(19) United States
(12) Patent Application Publication
(10) Pub. No.: US 2012/0318156 A1
(43) Pub. Date: Dec. 20, 2012

(54) PRINTER REAR PLATE MOUNTING ASSEMBLY

(75) Inventors: YU-CHENG HUANG, Tu-Cheng (TW); JENG-CHE CHEN, Tu-Cheng (TW)

(73) Assignee: HON HAI PRECISION INDUSTRY CO., LTD., Tu-Cheng (TW)

(21) Appl. No.: 13/327,863

(22) Filed: Dec. 16, 2011

(30) Foreign Application Priority Data
Jun. 20, 2011 (TW) 100121361

(51) Int. Cl. B41F 27/12

(52) U.S. Cl. 101/477

(57) ABSTRACT

A mounting assembly for mounting a rear plate of a printer is disclosed. The printer rear plate mounting assembly comprises a rear plate comprising a retaining member, an opening located in the rear plate, the retaining member comprising a connecting arm and a transmission portion connected to the connecting arm, a clasp located on a distal end of the connecting arm, the transmission portion comprising a pull portion which is aligned to the opening and accessible via the opening; and a mounting bracket defining an engaging hole, the clasp engaged in the engaging hole; wherein the pull portion is adapted to be pulled to bend the connecting arm, and the clasp is adapted to move out of the engaging hole.

### BACKGROUND

1. Technical Field

The present disclosure relates to mounting assemblies, more particularly, to a mounting assembly for mounting a rear plate of a printer.

2. Description of Related Art

When a printer is in use for a long period of time, many problems may occur, such as pieces of paper jamming in a cleanout cover of the printer. To remove the jammed pieces of paper, a rear plate of the printer may need to be detached. However, the rear plate is often not easily detachable from the printer.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded and isometric view of a printer rear plate mounting assembly.

FIG. 2 is an isometric view of the rear plate of FIG. 1.

FIG. 3 is a partially assembly view of the mounting assembly of FIG. 1.

FIG. 4 is a completed assembly view of the mounting assembly of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

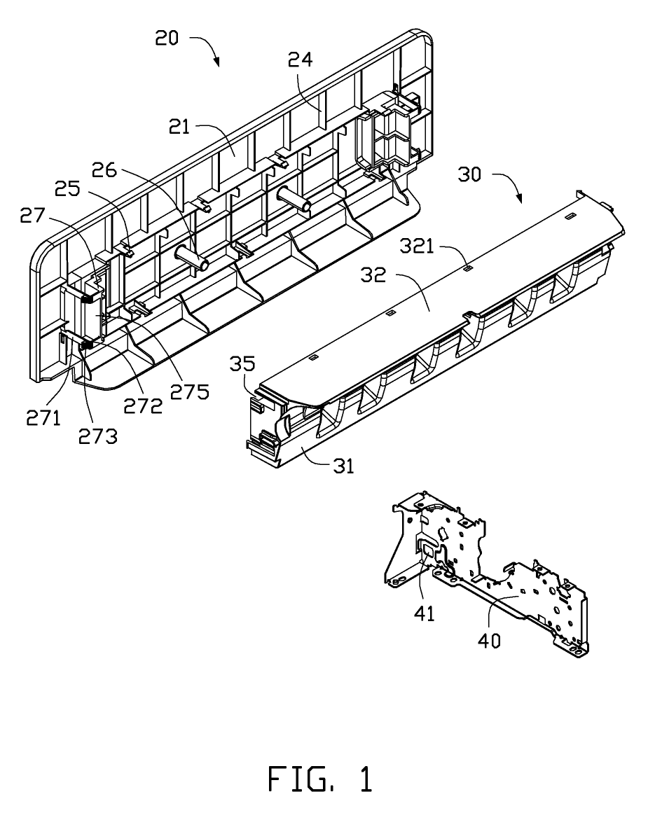

Referring to FIG. 1, a printer rear plate mounting assembly in accordance with an embodiment comprises a rear plate 20, a cleanout cover 30, and a mounting bracket 40.

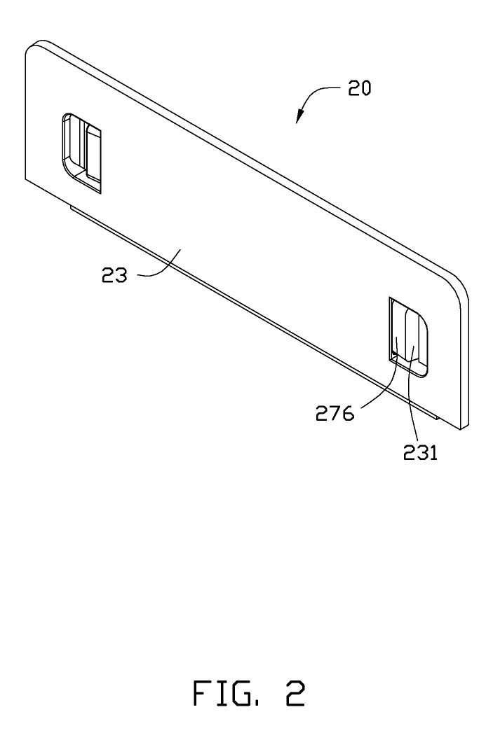

Referring to FIGS. 1 and 2, the rear plate 20 comprises a first side 21 and a second side 23 opposite to the first side 21. A plurality of ribs 24 is formed on the first side 21 to enhance the rear plate 20. A plurality of hooks 25 and a plurality of posts 26 are located on the first side 21. A pair of openings 231 is defined in the second side 23 extending through the rear plate 20. Each of the pair of openings 231 is located adjacent to an edge of the rear plate 20. A pair of retaining members 27 is located on the first side 21. Each of pair of the retaining members 27 comprises a pair of connecting arms 271, which is perpendicularly connected to the first side 21. Each of the pair of connecting arms 271 comprises a distal end 272. A clasp 273 is formed on the distal end 272. A transmission portion 275 is connected to the distal end 272 of each of the pair of connecting arms 271. The transmission portion 275 and the clasp 273 are located on opposite sides of each of the pair of connecting arms 271. The transmission portion 275 comprises a pull portion 276, which is far away from the pair of connecting arms 271. The pull portion 276 is aligned to each of the pair of openings 231 and accessible via each of the pair of openings 231.

The cleanout cover 30 comprises a mounting plate 31 and a cover plate 32. The cover plate 32 is generally perpendicular to rear plate 20. The mounting plate 31 defines a plurality of holes (not shown) corresponding to the plurality of posts 26 of the rear plate 20. Each opposite end of the mounting plate 31 respectively defines a pair of receiving slots 35 corresponding to the pair of connecting arms 271. The cover plate 32 defines a plurality of securing holes 321 corresponding to the plurality of hooks 25 of the rear plate 20.

The mounting bracket 40 is adapted to mounted in the printer. The mounting plate 40 defines a pair of engaging holes 41 corresponding to the clasps 273.

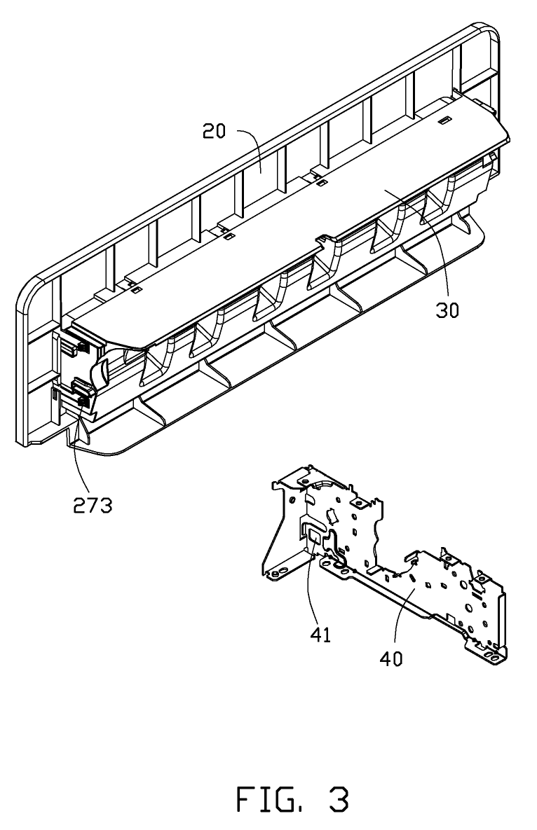

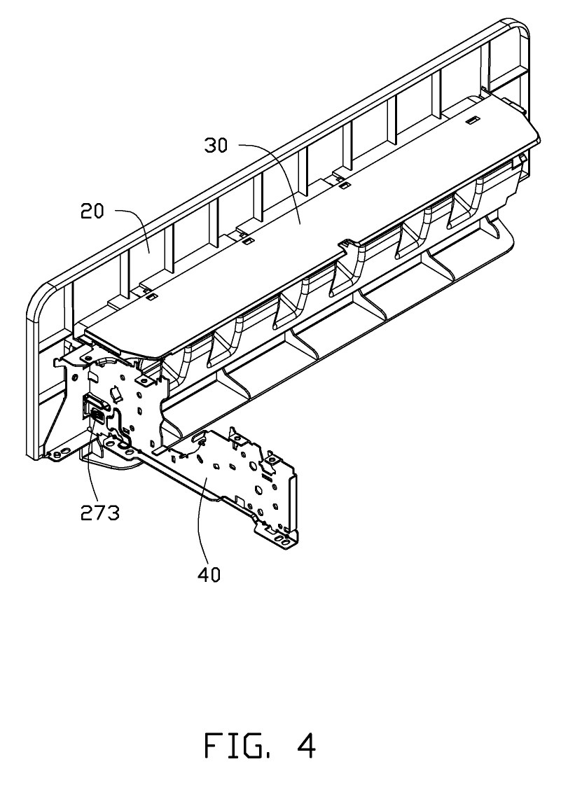

Referring to FIGS. 1 to 4, in assembly, the plurality of posts 26 of the rear plate 20 are inserted in the holes of the mounting plate 31. Each of the plurality of hooks 25 is mounted in corresponding one of the pair of securing holes 321. Each of the pair of connecting arms 271 is received in corresponding one of the pair of receiving slots 35 of the cleanout cover 30.

Then, the pull portion 276 of each of the pair of retaining members 27 is pulled. Each of the pair of connecting arms 271 of each of the pair of retaining members 27 is elastically bent. The clasp 273 is moved to align with one of the pair of engaging holes 41 of the mounting bracket 40. In succession, the pull portion 276 is released. Each of the pair of connecting arms 271 rebounds to have the clasp 273 located in one of the pair of engaging holes 41. Therefore, the rear plate 20 is mounted on the mounting bracket 40, which is mounted in the printer.

When paper is jammed in the cleanout cover 30, the pull portion 276 is pulled to bend each of the pair of connecting arms 271. The clasp 273 is moved out of one of the pair of engaging holes 41. Then, each of the plurality of hooks 25 is detached from one of the pair of securing holes 321 to detach the rear plate 20 from the printer. Then, paper can be pulled out from the cleanout cover 30.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A printer rear plate mounting assembly, comprising:
a rear plate comprising a retaining member, an opening located in the rear plate, the retaining member comprising a connecting arm and a transmission portion connected to the connecting arm, a clasp located on a distal end of the connecting arm, the transmission portion comprising a pull portion which is aligned to the opening and accessible via the opening; and
a mounting bracket defining an engaging hole, the clasp engaged in the engaging hole;
wherein the pull portion is adapted to be pulled to bend the connecting arm, and the clasp is adapted to move out of the engaging hole.

2. The printer rear plate mounting assembly of claim 1, further comprising a cleanout cover, wherein a plurality of hooks are located on a first side of the rear plate facing the mounting bracket; the cleanout cover defines a plurality of securing holes; and each of the plurality of hooks is mounted in each of the plurality of securing holes.

3. The printer rear plate mounting assembly of claim 2, wherein the cleanout cover comprises a cover plate perpendicular to the rear plate, and the plurality of the securing holes are in the cover plate of the cleanout cover.

4. The printer rear plate mounting assembly of claim 2, wherein the cleanout cover comprising a mounting plate, the mounting plate defines a receiving slot, and the connecting arm of the rear plate is received in the receiving slot.

5. The printer rear plate mounting assembly of claim 2, wherein the opening extends through the first side and a second side opposite to the first side of the rear plate, and the pull portion is accessible from the second side of the rear plate.

6. The printer rear plate mounting assembly of claim 1, wherein the transmission portion and the clasp are located on opposite sides of the connecting arm.

7. A printer rear plate mounting assembly, comprising:
a rear plate comprising a retaining member, an opening located in the rear plate, the retaining member comprising a connecting arm and a transmission portion connected to the connecting arm, a clasp located on a distal end of the connecting arm, and the retaining member accessible via the opening;
a cleanout cover mounted on the rear plate, the cleanout defining a receiving slot, and the connecting arm of the rear plate is received in the receiving slot; and
a mounting bracket defining an engaging hole, the clasp engaged in the engaging hole;
wherein the retaining member is adapted to be pulled to bend the connecting arm, and the clasp is adapted to move out of the engaging hole.

8. The printer rear plate mounting assembly of claim 7, wherein the retaining member comprises a pull portion, and the pull portion is aligned to the opening and accessible via the opening.

9. The printer rear plate mounting assembly of claim 7, wherein a plurality of hooks is on a first side of the rear plate facing the clean out cover, the cleanout cover defines a plurality of securing holes, and each of the plurality of hooks is mounted in each of the plurality of securing holes.

10. The printer rear plate mounting assembly of claim 9, wherein the cleanout cover comprises a cover plate perpendicular to the rear plate, and the plurality of the securing holes are in the cover plate of the cleanout cover.

11. The printer rear plate mounting assembly of claim 9, wherein the opening extends through the first side and a second side opposite to the first side of the rear plate, and the retaining member is accessible from the second side.

12. The printer rear plate mounting assembly of claim 7, wherein the transmission portion and the clasp are located on opposite sides of the connecting arm.
